(19) United States
(12) Patent Application Publication
(10) Pub. No.: US 2026/0146495 A1
(43) Pub. Date: May 28, 2026

(54) WINDOW INSERT WITH A MULTISENSORY INSTALLATION GUIDANCE SYSTEM

(71) Applicant: Dean Golub, Chicago, IL (US)

(72) Inventor: Dean Golub, Chicago, IL (US)

(21) Appl. No.: 18/963,620

(22) Filed: Nov. 28, 2024

(51) Int. Cl. E06B 7/28

(52) U.S. Cl. CPC E06B 7/28

(57) ABSTRACT

A window insert having a multi-part rigid frame. Said rigid frame having: at least one external attachment point, at least one internal cavity within which an object or objects can be encased, at least one hole into which an object or objects can be inserted, and differentiated surface features.

An installation guidance system of said frame and objects interacting to provide multisensory indication of proper or improper installation of said window insert.

An installation guidance system which provides multisensory indication of proper or improper installation of an insert.

### BACKGROUND OF THE INVENTION

A window insert installed into a window opening usually must engage the window apparatus as a means to prevent said window insert from falling out of said window opening. Users who install a window insert into a window opening rely upon their own judgement regarding proper installation. Users are not the same with regard to their understanding of physics and engineering. Some users would view an installation as proper while other users would view the same exact installation as improper. Improper installation of a window insert is unsafe and can cause injury and damage. My own U.S. Pat. No. 11,559,036 (2023) describes a window insert without an installation guidance system. The current invention reduces risk from improper installation of a window insert.

### SUMMARY

In accordance with one embodiment, a window insert is inserted into an opened window and adjusted to engage said opened window apparatus in several locations simultaneously. Said window insert provides multisensory indica which facilitate indication of proper as well as improper installation of said window insert into said opened window. Said window insert is removably attachable to various objects which facilitate proper installation of said objects within said opened window. Other embodiments can be shaped differently and emit electrically powered sounds, vibrations, and lights to indicate proper or improper installation of a window insert.

Accordingly, the advantages of one or more aspects of the current invention are as follows: to provide a window insert having a multisensory installation guidance system which reduces risk of injury or damage. Visually or hearing-impaired people can properly install said window insert.

### BRIEF DESCRIPTION OF THE DRAWINGS

FIG. 1 Perspective view of one embodiment of present invention from slightly above and to the left of the invention

FIG. 2 Elevation view of interactive parts of invention each of which moves independently to engage or disengage other parts of the invention.

### DETAILED DESCRIPTION OF THE DRAWINGS

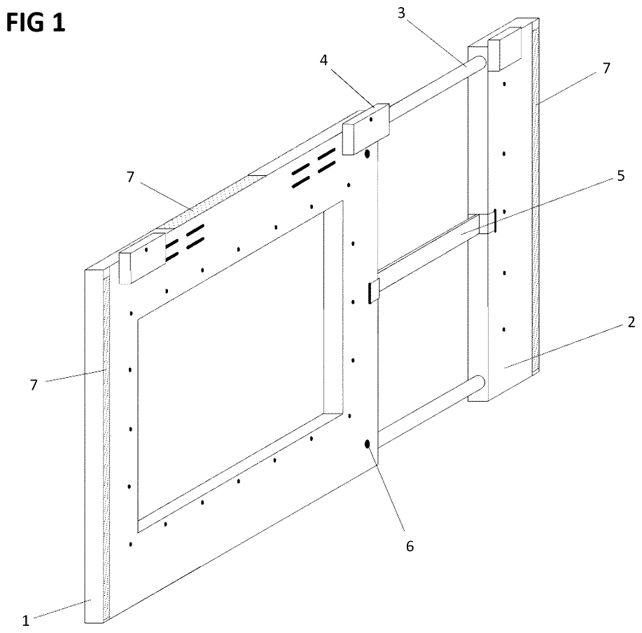

With regard to FIG. 1 which depicts a perspective view of the present invention. All parts of the invention not shown in FIG. 1 were deliberately omitted to show certain aspects of present invention. The surfaces of frame 1 and frame extension 2 can have distinguished areas 7. Frame 1 can be planarly shaped and have at least one large opening through which objects can traverse. Flange 4 can be pivotally mounted, flexibly mounted, or removably attachable to frame 1. Frame 1 can have at least one distinguished area 7 which is obscured by proper positioning or attachment of flange 4 to frame 1. Frame 1 and Extension 2 can have distinguished areas 7 which display bright coloring such as fluorescent orange, and texturing on surfaces which become obscured and inaccessible when window sash 9 and window retainers 10 properly engage members of present invention. Proper installation of invention is partially achieved when frame 1 is properly seated into one window retainer 10, frame extension 2 is properly seated into an opposing window retainer 10 from frame 1, the distance between frame 1 and frame extension 2 is fixed in an extended position within said window retainers, and window sash 9 is engaged with frame 1 and frame extension 2 within an opened window. Proper installation of present invention within said opened window covers said distinguished areas 7. The absence of bright coloring and texturing would indicate proper installation of invention within said opened window. Frame 1 can have distinguished areas 7 elsewhere as indicum providing the user a means to verify proper attachment of external members to frame 1. Frame 1 can have perpendicularly intersecting holes 6 in which frame extension guide 3 is seated providing a means to manipulate wedge 8 which frictionally engages frame extension guide 3 preventing said frame extension guide from sliding relative to frame 1. Frictionally engaging frame extension guide 3 with wedge 8 fixes the distance between frame 1 and frame extension 2 which provides a means to secure frame 1 and frame extension 2 into opposing window retainers 10. Said wedge 8 which engages frame extension guide 3 can have grooves or barbs which provide tactile and audible means to indicate wedge 8 is properly engaged with frame extension guide 3. Extension guide 3 can have a non-cylindrical feature along its length which wedge 8 cannot engage which indicates the need to slide extension 2 out from frame 1 to initiate engagement between wedge 8 and extension guide 3.

Indication of the need to slide extension 2 out from frame 1 to initiate engagement between wedge 8 and extension guide 3 is achieved by the interaction between the wedge 8 and extension guide 3. The interaction between wedge 8, extension guide 3, distinguished areas 7, flange 4, and attached objects facilitate indication of proper or improper installation of a window insert.

Frame 1 can have one or several internal cavities 11 which can accommodate internal objects such as springs, electronics, gears, cogs, and fasteners. Said electronics can be sensors, light emitting diodes, switches, vibrators, and sound emitters which can provide proper or improper installation indicum.

Depicted embodiment of coupler 5 flexibly attaches frame 1 to extension 2. Coupler 5 can be of different embodiments and serve more purposes than simply a means of flexible attachment of frame 1 to extension 2.

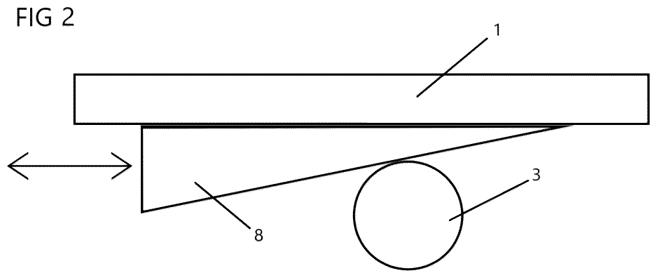

With regard to FIG. 2 which depicts an elevation view of a certain aspect of the invention. Wedge 8 can be slid between frame 1 and extension guide 3. Wedge 8 can have features which engage frame extension guide 3 differently dependent upon the position of said wedge relative to frame extension guide 3 and frame 1. As wedge 8 is slid perpendicularly over the surface of frame extension guide 3, resistance increases providing the user tactile indicum of frictional engagement with frame extension guide 3. Wedge 8 can be conically shaped. The surface of wedge 8 can have a cog, groove, or feature which engage other parts of the invention which emit an audible sound and tactile signal as said wedge 8 is slid over surfaces of frame extension guide 3 and frame 1.

### GLOSSARY

1. Frame Rigid object with surface features to which external objects can be removably attached and internal cavities which can contain objects. Frame can have a slidably connected to extension which facilitates adjustability. Frame can have at least one opening through which objects can traverse.
2. Extension Rigid object with surface features to which external objects can be removably attached and internal cavities which can contain objects. Extension is slidably connected to frame.
3. Extension Guide An elongated, cylindrically shaped object which guides extension.
4. Flange Object which protrudes from frame and engages an external object.
5. Coupler Object which flexibly attaches frame to extension.
6. Hole A hollow place in a solid body or surface.
7. Distinguished Area An area which differs from other areas.
8. Wedge A piece of a substance (such as wood or iron) that tapers to a thin edge and is used for tightening by being driven into something.
9. Window Sash A moveable section of a window otherwise known as a wing.
10. Window Retainer A channel which guides a window sash during movement and contains said window sash.
11. Cavity A void on or within an object.

1. An insert installation guidance system of interdependent members which interact to visually, tactilely, and audibly indicate proper or improper installation of an insert.

2. A window insert installation guidance system of interdependent members which interact to visually, tactilely, and audibly indicate proper or improper installation of a window insert.

3. A window insert comprising:
brightly colored indicum at predetermined locations on surfaces of said window insert which become obscured by window retainers and window sash when said insert properly engages said window retainers and said window sash simultaneously;
textured indicum at predetermined locations on surfaces of said window insert which become inaccessible when said insert properly engages said window retainers and said window sash simultaneously;
at least one member having the ability to engage other members of said window insert and indicate proper engagement of said members through visual, tactile, and audible indica;
at least one member to which objects can be attached to;
and interdependent members which interact and coordinate to visually, tactilely, and audibly indicate proper or improper installation of said window insert.
